(19) United States
(12) Patent Application Publication
(10) Pub. No.: US 2007/0006533 A1
(43) Pub. Date: Jan. 11, 2007

(54) Vehicle window lift plate

(75) Inventors: Paul Dedrich, Grand Blanc, MI (US); Steve Jones, Commerce, MI (US)

Correspondence Address: KAPLAN GILMAN GIBSON & DERNIER L.L.P., 900 ROUTE 9 NORTH, WOODBRIDGE, NJ, 07095, US

(73) Assignee: Faurecia Interior Systems U.S.A., Inc.

(21) Appl. No.: 11/178,877

(22) Filed: Jul. 11, 2005

(51) Int. Cl. E05F 11/38

(52) U.S. Cl. 49/375

(57) ABSTRACT

An apparatus is disclosed which may include a base; and a plurality of spring fingers arranged along a length of the base and defining an opening for receiving an edge of a window pane, the spring fingers adapted to provide respective spring forces to bias against the window pane, wherein a first spring finger is disposed on a first side of the opening and a second spring finger, nearest the first spring finger of any spring finger on a second side of the opening, is offset along the length of the base with respect to the first spring finger.

### BACKGROUND OF THE INVENTION

The present invention relates in general to a vehicle window lift plate and in particular to a lift plate for use in securely holding a vehicle window. Vehicle window lift plates are employed to secure window panes to regulators which control the movement of window panes. Conventional lift plates generally employ members to hold in place a window pane inserted therein.

However, the insertion of window panes into lift plates during the manufacture of vehicle window assemblies can suffer inconsistency in the position of the window panes relative to the lift plates due to human error during a manual insertion of the window pane and/or variation in the placement and adjustment of clamps or other mechanisms used for securing the window pane to the lift plate upon insertion. Some existing lift plates include pairs of directly opposed members to secure a window pane within a lift plate in which a portion of one of the members extends into a hole in the window pane. However, there remains a need in the art for a lift plate providing accurate, consistent, and secure attachment of window panes thereto without a need for human operator intervention.

### SUMMARY OF THE INVENTION

According to one aspect, the invention provides an apparatus comprising: a base; and a plurality of spring fingers arranged along a length of the base and defining an opening for receiving an edge of a window pane, the spring fingers adapted to provide respective spring forces to bias against the window pane, wherein a first spring finger is disposed on a first side of the opening and a second spring finger, nearest the first spring finger of any spring finger on a second side of the opening, is offset along the length of the base with respect to the first spring finger. Preferably, the plurality of spring fingers comprises a first group of spring fingers disposed on the first side of the opening and a second group of spring fingers disposed on a second side of the opening, wherein none of the spring fingers are disposed directly opposite any other spring finger. Preferably, one of the first group and the second group includes one more spring finger than the other of the first group and the second group. Preferably, the plurality of spring fingers comprises at least three spring fingers. Preferably, the first spring finger includes a tab operable to engage a hole in the window pane upon the receiving of the edge of the window pane into the opening. The tab on the spring finger is preferably inclined such that, when inserted into the hole of the window pane, the tab will preferably always be in contact with the hole in the window pane regardless of dimensional variances, within specification, of the hole size or position in the window pane.

Preferably, the first spring finger is a middle spring finger of the plurality of spring fingers. Preferably, the apparatus is operable to securely engage the window pane without intervention by a human operator. Preferably, the tab automatically engages the hole in the window pane upon insertion of the window pane into the apparatus. Preferably, the tab includes a downwardly directed distal end. Preferably, the spring fingers include distal ends that are curved, thereby forming a chamfer for receiving the edge of the window pane. Preferably, the spring fingers are springingly biased against the window pane, thereby providing a compression bias against the window pane. Preferably, at least one spring finger is coupled to a brace operable to increase a biasing spring force of the at least one spring finger against the window pane. Preferably, the apparatus further comprises at least one support member on the base operable to bias upward against the edge of the window pane.

According to another aspect, the invention provides a method that may include providing a lift plate having a base and a plurality of spring fingers arranged along a length of the base and defining an opening for receiving an edge of a window pane; providing at least one compression member extending from the base; inserting the window pane into the lift plate; springingly biasing the spring fingers against the window pane to provide a compression force; and springingly biasing the at least one compression member against the edge of the window pane to provide a resistance to a compression force created by the spring fingers. Preferably, a first spring finger is disposed on a first side of the opening and a second spring finger, nearest the first spring finger of any spring finger on a second side of the opening, is offset along the length of the base with respect to the first spring finger. Preferably, the method further comprises providing a tab on a first spring finger of the spring fingers; providing a hole within the window pane; and engaging the hole by the tab upon the receipt of the edge of the window pane into the opening. Preferably, the method further comprises springingly suspending the window pane, along a direction of the insertion, between the at least one compression member and the tab. Preferably, the method further comprises locating at least one compression member beneath a spring finger.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a perspective view of a lift plate having a plurality of spring fingers in accordance with one or more aspects of the present invention;

FIG. 2 is rear elevational view of the lift plate of FIG. 1;

FIG. 3 is a planar view of a window pane suitable for insertion into the lift plate of FIG. 1 in accordance with one or more embodiments of the present invention;

FIG. 4 is a sectional view of the engagement of the window pane of FIG. 3 by the tab of the middle spring finger on the lift plate of FIG. 1;

FIG. 5 is a partially sectional and partially elevational view of the window pane of FIG. 3 located within the lift plate of FIG. 1 in accordance with one or more embodiments of the present invention; and

FIG. 6 is a partially sectional and partially elevational view of the window pane of FIGS. 3 and 4 being supported by a support member on the lift plate of FIG. 1 in accordance with one or more embodiments of the present invention.

### DETAILED DESCRIPTION OF THE PREFERRED EMBODIMENTS

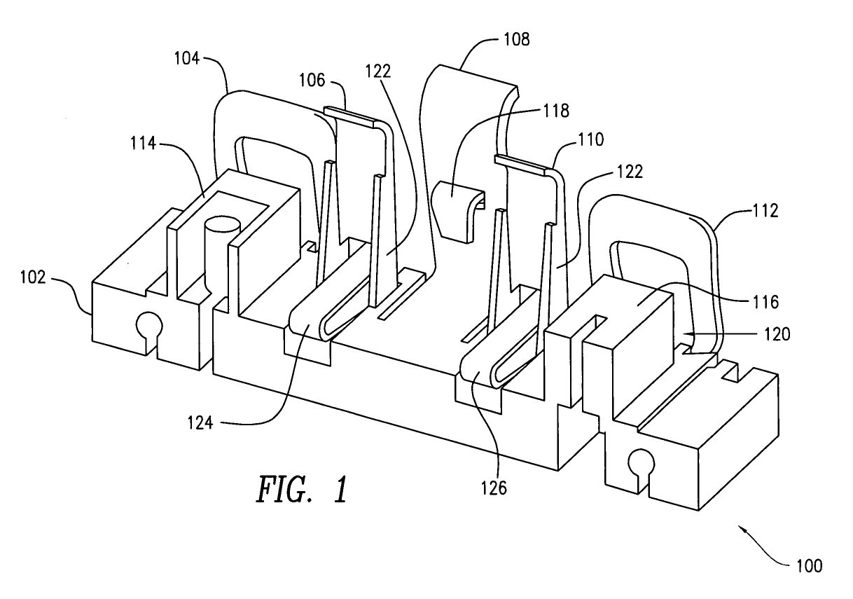

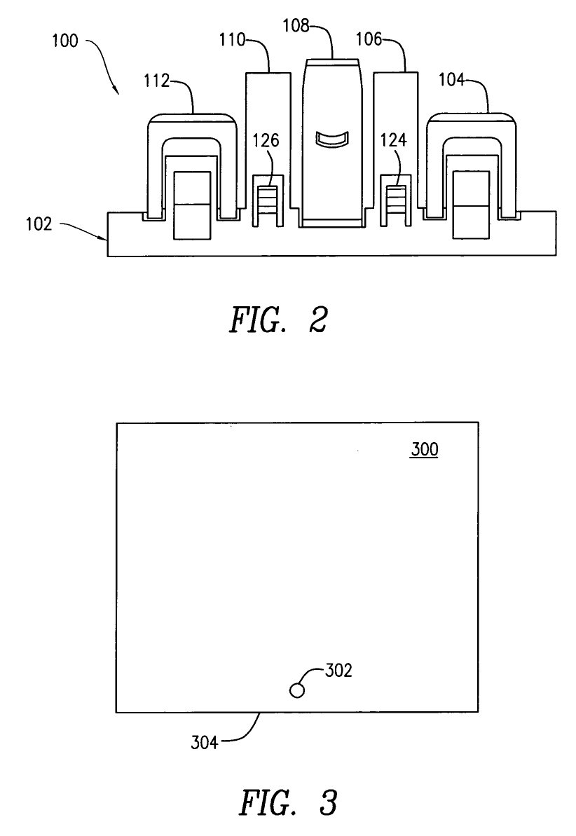

In the following discussion, reference is made to FIGS. 1-3. FIG. 1 is a perspective view of a lift plate 100 having a plurality of spring fingers in accordance with one or more aspects of the present invention. FIG. 2 is a rear elevational view of lift plate 100, and FIG. 3 shows a window pane that is suitable for insertion into lift plate 100 and that preferably includes a hole 302 therethrough and a bottom edge 304.

Referring to FIG. 1, lift plate 100 preferably includes base 102 and spring fingers 104-112. Base 102 preferably includes blocks 114 and 116. Five spring fingers 104, 106, 108, 110, and 112 are shown, however two or more spring fingers may be used in connection with preferred embodiments of the present invention. Lift plate 100 also includes braces 122 coupled to respective spring fingers 106 and 108 and support members 124 and 126 extending upward from base 102. Herein, the term “compression member” corresponds to the term “support member.”

In this embodiment, spring fingers 104-112 preferably define an opening 120 into which window pane 300 bottom edge 304 may be inserted. Preferably, a first group of spring fingers 104, 108, and 112 are located on a first side of opening 120, and a second group of spring fingers 106 and 110 are located on a second side of opening 120. In a preferred embodiment, at least one spring finger within the first group of spring fingers is offset along the length of opening 120 from the nearest spring finger thereto in the second group of spring fingers. Otherwise stated, preferably, at least one spring finger of the plurality of spring fingers of lift plate 100 is not directly opposite any other spring finger.

In the embodiment of FIG. 1, the foregoing concept is extended throughout lift plate 100, with each of the spring fingers being offset, along the length of opening 120, from the nearest spring finger thereto on the other side of opening 120. Thus, in FIG. 1, no spring finger is disposed directly opposite any other spring finger within lift plate 100. However, the present invention is not limited to the embodiment shown in FIG. 1. In alternative embodiments, one or more spring fingers may at least partially overlap.

In the embodiment of FIG. 1, middle spring finger 108 includes tab 118. However, in one or more other embodiments, tab 118 could be located on one or more spring fingers, in addition to or instead of spring finger 108, of lift plate 100. In one or more further embodiments, tab 118 may be completely omitted from lift plate 100.

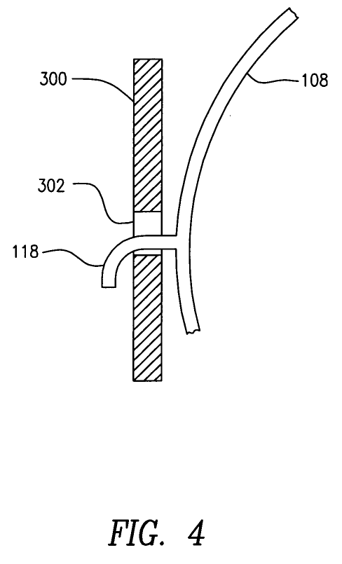

Tab 118 preferably includes a proximal end (the end closest to the body of spring finger 108), and a distal end which preferably extends through hole 302 in window pane 300. In this embodiment, tab 118 preferably includes a downwardly directed distal end, as shown in FIG. 4. This preferred shape for the distal end of tab 118 preferably operates to more effectively secure window pane 300 within lift plate 100. Moreover, other shapes of tab 118 may be employed. Tab 118 may be shaped so as to effect desired contact geometry between tab 118 and hole 302 in window pane 300. Specifically, the length of tab 118 in contact with the perimeter of hole 302 in window pane 300, once window pane 300 is substantially fully inserted into lift plate 100, may be controlled by adjusting the shape of tab 118.

Upon inserting window pane 300 into lift plate 100, the lower edge 304 of window pane 300 is preferably received into opening 120. Upon at least substantially completing the insertion of window pane 300 into lift plate 100, tab 118 preferably automatically engages hole 302 in window pane 300.

Tab 118 preferably extends through at least a portion of the length of hole 302, thereby aiding in securing window pane 300 to lift plate 100. In one or more embodiments, tab 118 may extend substantially all the way through hole 302 upon fully engaging hole 302. In one or more further embodiments, tab 118 may extend through the entire length of hole 102 once window pane 300 is fully received into opening 120 of lift plate 100.

In the embodiment of FIG. 1, spring fingers 104-112 preferably provide respective spring forces to bias against window pane 300, once received within lift plate 100, to secure window pane 300 within lift plate 100. Preferably, the combination of the spring forces from spring fingers 104-112 and the engagement of hole 302 by tap 118 enable lift plate 100 to securely engage window pane 300 without a need for intervention by a human operator.

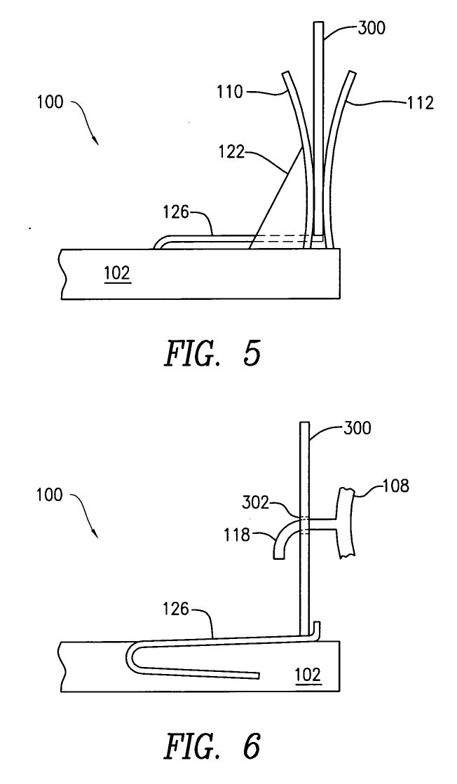

FIG. 5 is a partially sectional and partially elevational view of window pane 300 positioned within lift plate 100 in accordance with one or more embodiments of the present invention. For the sake of simplicity, the securing of window pane 300 by tab 118 is not shown in FIG. 5. However, in a preferred embodiment, the engagement of hole 302 by tab 118 may be practiced in conjunction with the features illustrated in FIG. 5.

Each spring finger preferably includes a proximal end located on or near base 102 and a distal end. In this embodiment, the distal ends of spring fingers 110 and 112 are preferably curved away from their respective sides of window pane 300. The curved distal ends of spring fingers 110 and 112 thereby preferably combine to form a chamfer for receiving window pane 300 into lift plate 100.

In a preferred embodiment, the spring fingers, including spring fingers 110 and 112 shown in FIG. 5, are springingly biased against window pane 300 to secure window pane 300 within lift plate 100. Preferably, as window pane 300 is inserted into lift plate 100, spring forces from the respective spring fingers acting on window pane 300 operate to position window pane 300 at a point along the direction of the spring forces (i.e. the left-to-right dimension in FIG. 5) where all such spring forces are in equilibrium.

In a preferred embodiment, brace 122 is a preferably triangularly shaped member located on the upper surface of base 102 and in contact with a substantial portion of the length of one or more spring fingers, such as spring finger 110, as shown in FIG. 5. However, brace 122 is not limited to being triangular. In alternative embodiments, brace 122 could have any shape including but not limited to being square or rectangular. Moreover, brace 122 is not limited to being coupled to spring finger 110 along a lower portion of spring finger 110, as shown in FIG. 5, but may instead be located along any portion of spring finger 110. Preferably, brace 122 operates to bolster spring finger 110, thereby increasing the biasing spring force of spring finger 110 against window pane 300.

In a preferred embodiment, once window pane 300 is fully inserted into lift plate 300, the bottom edge 304 of window pane 300 rests against support members 124 and 126 (FIG. 1). Support members 124 and 126 are shown located underneath spring fingers, 106 and 110, respectively. However, in alternative embodiments, support members 124 and 126 may be located anywhere on base 102 of lift plate 100, as long as support is provided for window pane 300 upon insertion thereof into lift plate 100. A more detailed view of support member 126 is provided in FIG. 6, which is a partially sectional and partially elevational view of window pane 300 being supported by support member 126 on lift plate 100 in accordance with one or more embodiments of the present invention. For the sake of simplicity, some parts of lift plate 100 are omitted from FIG. 6, and only a portion of base 102 and spring finger 108 are shown therein. While, for the sake of simplicity, the following remarks in connection with FIG. 6 address the operation of support member 126, it is noted that support member 124 preferably has the same structure and operates in tandem with support member 126.

In a preferred embodiment, once window pane 300 is fully inserted into lift plate 100, it partially deflects support member 126, thereby causing support member 126 to generate a spring force that biases upward against the bottom edge 304 of window pane 300. Thus, in this embodiment, window pane 300 preferably experiences an upward biasing force from support member 126 (and optionally one or more additional support members) and preferably experiences a force in the reverse direction from tab 118 of spring finger 108 (and optionally one or more additional tabs). Preferably, the combination of frictional forces (of window pane 300 against the surfaces of the plurality of spring fingers), the upward forces from support members 124 and 126, and the downward force from tab 118 of spring finger 108 are in equilibrium, thereby keeping window pane 300 stationary within lift plate 100. Thus, in one or more embodiments, window pane 300 is preferably springingly suspended within lift plate 100 by the forces acting thereon.

In the foregoing, the term “upward” was used to describe a force acting away from base 102, since in one or more preferred embodiments, lift plate 100 is oriented such that the exposed surface of base 102 is horizontal. Correspondingly, the “reverse direction” referred to above corresponds to a downward force in one or more preferred embodiments. However, it will be appreciated by those of ordinary skill in the art that the present invention is not limited to being used in embodiments in which the insertion direction of window pane 300 is vertical. In alternative embodiments, insertion may occur along any direction in three-dimensional space. In such alternative embodiments, the spring-force directions of support members 124 and 126 and of tab 118 would preferably change along with the orientation of lift plate 100. Due to the various mechanisms for receiving, guiding, and securing window pane 300 within lift plate 100, the insertion of window pane 300 into lift plate 100 can preferably be securely conducted in any direction.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus comprising:
a base; and
a plurality of spring fingers arranged along a length of said base and defining an opening for receiving an edge of a window pane, said spring fingers adapted to provide respective spring forces to bias against said window pane,
wherein a first said spring finger is disposed on a first side of said opening and a second said spring finger, nearest said first spring finger of any spring finger on a second side of said opening, is offset along said length of said base with respect to said first spring finger.

2. The apparatus of claim 1 wherein said plurality of spring fingers comprises a first group of said spring fingers disposed on said first side of said opening and a second group of said spring fingers disposed on a second side of said opening, wherein none of said spring fingers are disposed directly opposite any other said spring finger.

3. The apparatus of claim 2 wherein one of said first group and said second group includes one more said spring finger than the other of said first group and said second group.

4. The apparatus of claim 3 wherein said plurality of spring fingers comprises at least three said spring fingers.

5. The apparatus of claim 1 wherein said first spring finger includes a tab operable to engage a hole in said window pane upon said receiving said edge of said window pane into said opening.

6. The apparatus of claim 5 wherein said first spring finger is a middle spring finger of said plurality of spring fingers.

7. The apparatus of claim 5 wherein said apparatus is operable to securely engage said window pane without intervention by a human operator.

8. The apparatus of claim 5 wherein said tab automatically engages said hole in said window pane upon insertion of said window pane into said apparatus.

9. The apparatus of claim 5 wherein said tab includes a downwardly directed distal end.

10. The apparatus of claim 1 wherein said spring fingers include distal ends that are curved, thereby forming a chamfer for said receiving said edge of said window pane.

11. The apparatus of claim 1 wherein said spring fingers are springingly biased against said window pane.

12. The apparatus of claim 1 wherein at least one said spring finger is coupled to a brace operable to increase a biasing spring force of said at least one spring finger against said window pane.

13. The apparatus of claim 1 further comprising at least one compression member on said base operable to bias upward against said edge of said window pane.

14. A method, comprising:
providing a lift plate having a base and a plurality of spring fingers arranged along a length of said base and defining an opening for receiving an edge of a window pane;
providing at least one compression member extending from said base;
inserting said window pane into said lift plate;
springingly biasing said spring fingers against said window pane; and
springingly biasing said at least one compression member against said edge of said window pane.

15. The method of claim 14 wherein a first said spring finger is disposed on a first side of said opening and a second said spring finger, nearest said first spring finger of any spring finger on a second side of said opening, is offset along said length of said base with respect to said first spring finger.

16. The method of claim 14 further comprising:
providing a tab on a first spring finger of said spring fingers;
providing a hole within said window pane; and
engaging said hole by said tab upon said receiving said edge of said window pane into said opening.

17. The method of claim 16 further comprising:
springingly suspending said window pane, along a direction of the insertion, between said at least one compression member and said tab.

18. The method of claim 14 further comprising:
locating at least one said compression member beneath a spring finger.
